(19) United States
(12) Patent Application Publication
(10) Pub. No.: US 2012/0131170 A1
(43) Pub. Date: May 24, 2012

(54) SYSTEM AND METHOD FOR FULFILLING REQUESTS USING A MOBILE DEVICE

(76) Inventor: William John Spat, North Vancouver (CA)

(21) Appl. No.: 13/388,289

(22) PCT Filed: Aug. 20, 2010
(86) PCT No.: PCT/CA2010/001269

§ 371 Date: Jan. 31, 2012

(30) Foreign Application Priority Data
Aug. 21, 2009 (US) 61369012
Jul. 29, 2010 (US) 235688

(51) Int. Cl. G06F 15/173

(52) U.S. Cl. 709/223

(57) ABSTRACT

A method and system of providing an on-demand service to a requester selectable from a group of requesters is provided, each of the requesters having a mobile device at an associated location. The requesters use the mobile device to request a service from a server. The server makes available the requests to eligible service providers for display and selection. On selection of a request by a service provider, the request is removed from display.

This application claims the benefit of U.S. Provisional Patent Application No. 61/235,688, filed on Aug. 21, 2009; and U.S. Provisional Patent Application No. 61/369,012, filed Jul. 29, 2010, both of which are hereby incorporated by reference in their entirety.

### FIELD OF THE INVENTION

The present invention relates to requesting services from mobile devices, and fulfilling such requests, and more particularly fulfilling such requests sent from a mobile device capable of providing location information.

### BACKGROUND

Efficiency of furnishing on-demand goods and services is frequently governed by the extent to which capacity of a system furnishing the goods or services is utilized. For example, a passenger transportation system which travels with fewer empty seats or places for passengers will generally provide more efficient passenger transportation services than a similar system which travels with a greater number of empty seats or places. Similarly, a goods provisioning system which fills more space dedicated to conveying goods will generally furnish goods more efficiently than a system which fills less space dedicated to conveying goods. This extent to which capacity of a system furnishing goods or services is utilized is often referred to as ‘load factor.’

Given the importance of load factor to efficient delivery of on-demand goods and services, many systems, methods, and techniques are used to optimize load factor. Some methods for optimizing load factor include route optimization and capacity optimization. Route optimization generally works by dictating a path or paths for systems furnishing a good or service such that load factor is optimized. Capacity optimization generally focuses on optimizing the disposing elements of systems for furnishing goods or services. Combinations of optimization methods are possible, and indeed frequent, since route and capacity variables tend to be interdependent in many systems for furnishing on-demand goods or services.

Route optimization can take many forms, from simple selection of appropriate starting and ending points, to complex algorithms which set best paths by which goods and services are furnished. Route optimization tends to be computationally intensive, and difficult to change quickly. For example, if a delivery van following turn by turn instructions to collect and deliver a series of parcels fails to reach a particular address along an optimized path at an appropriate time, it can be difficult to recalculate a new optimized path for the delivery van such that other collection and delivery time and location imperatives continue to be met in a timely and efficient fashion. As a result, the van may operate far from optimally for the remainder of the trip.

Capacity optimization also takes many forms, the commonality generally being an attempt to position elements of a system furnishing the goods or services such that the system responds to requests quickly, and with minimum functioning at sub-optimal load factor. Capacity optimization can also be computationally intensive, and can fail to optimize load capacity when positions of elements of the system do not correspond to experienced demand. For example, in order to optimize capacity in taxi systems, an area such as a city from which requests for passenger transportation service frequently originate is often divided into zones. Within each zone, taxis circulate in a virtual queue, with a first taxi in the queue responding to a request for transportation services originating within that zone. Once that taxi's capacity is utilized, the next request for services originating within the zone passes to the next taxi in the queue, and so on. When a passenger alights, capacity of the vehicle again becomes available for utilization by the transportation system, this time at the end of the queue in the zone in which the passenger alights. Difficulties in optimizing load factor can appear when requests for service arising within a zone outstrip capacity of vehicles circulating within that zone to furnish transportation services in a timely manner, or when inadequate demand for services originates from a zone in which vehicles are circulating. A public may experiences these difficulties in the guise of trouble finding an unoccupied taxi downtown after a big game, or in taxis that are unwilling to take paying fares to suburbs.

This optimization of the load factor becomes more complex when summoning on-demand goods and services and, more particularly, conveying a request for a specific service simultaneously to multiple providers of said goods or services. The efficiency of summoning on-demand goods and services is compromised by the time it takes to convey basic information about the nature of the goods and services requested to competing providers who might be in a position to supply the goods and services, and by the time it takes competing providers to acknowledge that they are prepared to provide the on-demand goods or services. For example, a passenger in need of taxi service might have to search through multiple potential providers of taxi services before finding a provider capable of fulfilling his or her request for service. This search might entail multiple unsuccessful attempts at contacting potential providers, either because communication lines or passing vehicles are already engaged, or because a provider eventually contacted is for some other reason not in a position to provide the on-demand service requested. And even when a provider who is in a position to furnish the goods or service requested is successfully contacted, still more time is required to convey to the provider the nature of, and location at which, the goods or services in question are being requested.

For example, hailing is a popular method of summoning on-demand goods or services, particularly taxis. The person in immediate need of a particular good or service seeks to convey to potential providers his or her request for that good or service by means of hailing sounds or gestures. Hailing is generally limited to earshot and line of sight channels of communication; the ability of the person requesting the good or service to accurately and efficiently convey the nature of their request over those channels; and the sequential evaluation of potential providers of the requested goods and services. That is, if, in the view of the person requesting the goods or services, an initial hail is not successfully conveyed, accepted, or completed, the hailing words or gestures are repeated until that person is satisfied that his or her request is met, or will be met within a reasonable delay.

Communication innovations have altered the hailing process to summon goods and services by wired, wireless, and other channels of communication beyond the limitations of vocal and gestural hailing. Some such communication innovations have extended the range of vocal and gestural hailing, so that distance limitations of earshot and line of sight channels may be overcome. However, these same communication innovations may impose other limitations on the hailing process, including increasing the amount of information that must be explicitly conveyed, or restricting the number of providers of good or service to which a request for service may be simultaneously conveyed. For example, a hailing gesture made in the street to summon a taxi is an open request to any provider of taxi services in sight of the gesture, whereas a telephone call to a taxi company is a request to a specific taxi fleet which may or may not be in a position to provide the service requested within an acceptable delay. If the provider of services initially contacted is not in a position to provide the services requested, the telephone must be used again to sequentially convey the request for service to another provider who may be in a position to provide the goods or services required. Furthermore, the location of the request, which is commonly evident in the case of a visible or audible hailing gesture, may have to be explicitly conveyed to the provider in the case of some communication innovations such as the telephone.

Other advancements have extended the range of hailing by increasing the ease with which details concerning a request for goods or services may be conveyed. For example, a 911 emergency service request placed from a mobile telephone may automatically convey location data associated with the mobile telephone, so that the 911 request conveys both the information that emergency services are needed, and the location at which the emergency services may be needed. This is a great improvement on a “Mayday” call by which would have to be followed by positional information transmitted by the originator of the request.

US20090176508A1 (also WO2009089182A1) to Lubeck et al., discloses a method for requesting services through the use of mobile communication devices capable of providing their geographic location. This method does not allow the initial request for service to be met without the service provider generating a first confirmation signal on a wireless communications network.

Other related art includes: WO2005022426; WO2009058117; EP0956717; U.S. Pat. No. 7,263,437; U.S. Pat. No. 7,499,714; U.S. Pat. No. 7,706,808; US20020143655; US20030125963; US20050165886; US20050283308; US20070197231; US20020095326; US20040260470; US20080015923; US20090037194; WO2002037323; WO2005027545; US20020077876; CN101577855; FR2857548; KR20050003078; KR20030066477; JP2009026217; JP2002312895; SE523951; and WO2009092169.

### SUMMARY OF THE INVENTION

The invention, a system and method for using location-enabled mobile devices to efficiently fulfill requests for a specific good or service, includes a system and method for providers of the requested good or service to acknowledge requests for a specific good or service to be fulfilled, and more efficiently provide the demanded good or service.

A method of providing an on-demand service to a requester selectable from a group of requester is provided, each of the requesters at an associated location, each of the requesters having a mobile device, including: a) each of the mobile devices communicating the associated request for service to a server, said request including the location associated with the mobile device; b) the server displaying the requests to each of the providers through an interface to the server, each of the requests including the location of the associated mobile device; wherein on selection of a request by a provider, the server removes the selected request from the display to the plurality of providers thereby preventing a second provider from selecting the request.

A system for providing an on-demand service to a requester selectable from a plurality of requesters is provided, each of the requesters at an associated location, each of the requesters having a mobile device, including: a) a server configured to receive requests for the service from the mobile devices, the requests including the location associated with the mobile devices and information for use in contacting said mobile device; b) the server accessible by the plurality of providers, each of the providers enabled to view requests for which the service provider is eligible, including the location of the associated mobile device; wherein on selection of a request by a provider, the server removes the selected request from display to the plurality of providers thereby preventing a second provider from selecting the request.

A method of providing a service to a plurality of requesters is provided, each of the requesters at an associated location, the requesters each having an associated mobile device, including: a) the mobile device communicating the requests for the service to a server, the requests each including the location associated with the mobile phone and a destination associated with the requester; b) the server displaying the requests, the associated locations and associated destinations to each eligible provider, the requests displayed in an order associated with proximity of the associated locations and direction of associated destinations, each of the requests associated with a selection indicator.

Still further objects, advantages, and applications may become apparent from a study of the following description and the accompanying drawings.

### BRIEF DESCRIPTION OF THE FIGURES

FIG. 1 is a block diagram showing a system according to an embodiment of the invention;

FIG. 2 is a flow chart showing the method according to an embodiment of the invention;

FIGS. 3A to 3E show screens for presentation on a mobile device according to an embodiment of the system;

FIGS. 4A to 4D show screens for presentation on a display of a service provider according to an embodiment of the invention; and

FIG. 5 is a flow chart showing the method according to an embodiment of the invention wherein a service share has been requested.

### DETAILED DESCRIPTION OF THE INVENTION

The system and method according to the invention provide a means whereby the user of a mobile device, having a computing environment capable of operating client software, such as a cellular phone, smart phone, PDA, iPod, iPad, or laptop computer, can access an on-demand service. An on-demand service is defined in this document as a service which is requested for provision as soon as possible, and for which the location for the delivery of the service is not known prior to the request being made. An example of an on-demand service includes the provision of taxi services, or other transportation services. Other examples of on-demand services could include pizza delivery, or courier services.

The following discussion provides a brief and general description of a suitable computing environment in which the server, service provider computer, and mobile device included in various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computing system configurations, including mobile devices, multiprocessor systems, microprocessor-based or programmable consumer electronics, personal computers (“PCs”), network PCs, mini-computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

As used herein, the terms “computer” and “server” are both computing systems as described in the following. A computing system may be used as a server, and includes one or more processing units, system memories, and system buses that couple various system components including system memory to a processing unit. Computing system will at times be referred to in the singular herein, but this is not intended to limit the application to a single computing system since in typical embodiments, there will be more than one computing system or other device involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

A computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

A computing system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, memory sticks, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in an embodiment may be markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft.

The operating system and various applications/modules and/or data may be stored on the hard disk of the hard disk drive, the optical disk of the optical disk drive and/or the magnetic disk of the magnetic disk drive.

A computing system can operate in a networked environment using logical connections to one or more other computing systems and/or one or more database systems, such as one or more remote computers or networks. A computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, a computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in many instances a computing system will operate automatically, where an end user application interface is provided, an operator can enter commands and information into the computing system through an end user application interface including input devices, such as a keyboard, and a pointing device, such as a mouse, or a human digit on a touch screen. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device may be coupled to the bus via a video interface, such as a video adapter (not shown). The computing system can include other output devices, such as speakers, printers, etc.

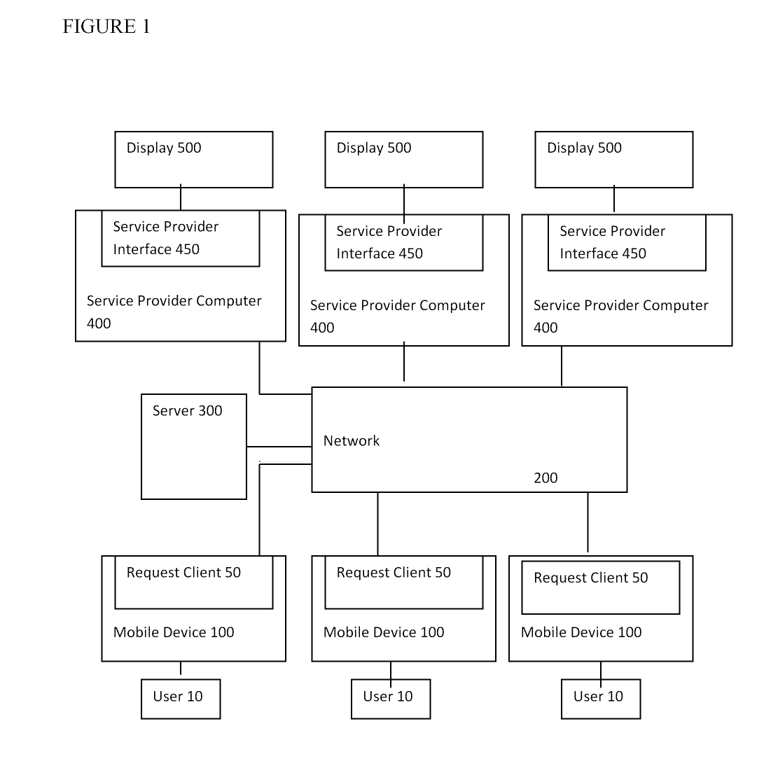

As seen in FIG. 1, a typical embodiment of a system according to the invention is shown. A user 10 operates request client 50 using mobile device 100. Mobile device 100 is in wireless communication with server 300 via network 200. Network 200 may be wired or wireless, or a combination thereof.

Server 300 is also in communication with a number of service provider computers 400, such as those operated by taxi dispatchers. Service provider computers 400 operate service provider interface 450. A service provider may be a single entity (e.g. a single taxi cab), in which case the service provider will likely be operating a mobile device; or an entity responsible for a number of service providers (e.g. a taxi dispatcher). Each service provider computer 450 has a display 500 on which communications from server 300 can be observed when operating service provider interface 450.

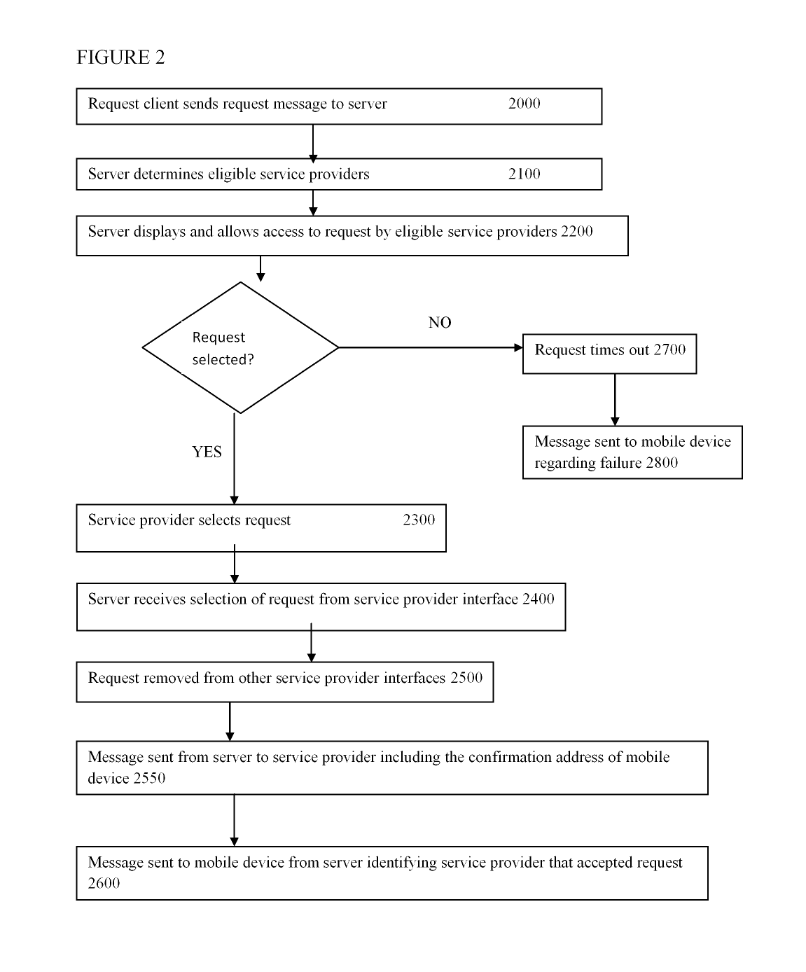

When actuated by user 10, and as seen in FIG. 2, at step 2000, request client 50 sends a request message to server 300. The sending of the request message may be actuated by a single “button” press on a touch screen mobile device, or by a single key press. In such a case, the request will include information about the geographical location of the mobile device, which may be determined using the Global Positioning System (GPS) software operating on the mobile device, or a Wi-Fi location from which the request is sent, cellular tower triangulation, or other means; and a confirmation address, such as the number of the mobile device, or an email address. The confirmation address may be provided by user 10 when initially installing or configuring request client 50.

Alternatively, the request may be changed by the user 10 to provide further information. This additional information could include an alternate location (for example if the user desired taxi services at a location different from his or her current position), a destination location, or a name of a person to receive the service. The request may include other information such as whether special circumstances are involved (e.g. the person needing a taxi is handicapped), whether a delivery from a taxi is requested, and if a limousine is requested.

In an embodiment of the invention, the request includes spatial coordinates, such as latitude/longitude, Universal Transverse Mercator (UTM) coordinates, or Cartesian coordinates, of the mobile device 100. If a destination is provided, the information can be represented in the request as a starting point (i.e. the location of the mobile device), and a vector in the appropriate direction, with the length corresponding to the destination.

Once server 300 receives the request, it processes the request (step 2100) by determining which service providers 400 are eligible to receive the request. The eligibility of a service provider depends on a number of factors. In some jurisdictions, for example, the ability of the service provider to provide a service may depend on the location where the service is being initiated. For example, some municipalities only allow certain taxi companies to pick up fares within certain boundaries. Other service providers may only operate during certain times.

A service provider may define the boundary within which they will accept requests by drawing a line or lines on a map provided by service provider interface 450. Service providers may change the display by selecting or “drawing” different lines at any time. When a boundary is defined or changed, it is communicated to server 300, which uses the boundary, or new boundary, to determine eligibility of the service provider. Interface 450 allows service providers to access requests on server 300 for which they are eligible.

Service provider interface 450 will convert such drawn boundary to spatial coordinates and simply not provide the service provider requests from outside the boundary. In another embodiment of the invention, a similar boundary could be provided for destinations, so that the service provider may exclude destinations that are too distant or otherwise undesirable.

Server 300 then provides the request to eligible service provider interface 450 (step 2200). The request will appear on display 500. Display 500 may simply list the information associated with the request, or an interactive map may be provided showing the location associated with the request, and perhaps the location of the entities that can provide the service (such as the taxi cabs).

When a service provider 400 selects a request (step 2300), service provider interface 450 sends a message to server 300 (step 2400), which then removes the request from displays 500 of all other service providers (step 2500). A message is provided from server 300 to the first service provider to select the request including the confirmation address of the user (step 2550), so that the service provider can contact the user to confirm provision of the services. Server 300 also sends a message to mobile device 100, such as a text message, email or voice recording, indicating which service provider will be providing the service and contact information for that service provider (step 2600).

In an embodiment of the invention, service providers may have the option of declining a request by selecting an appropriate area of display 500 associated with the request. In such a case, the request will be removed from the display of that service provider only. If all eligible service providers decline a request, server 300 generates a failure message for mobile phone 100.

If no service provider 400 selects a request after a predetermined time, the request times out (step 2700), and a failure message is generated by server 300 for mobile device 100 (step 2800).

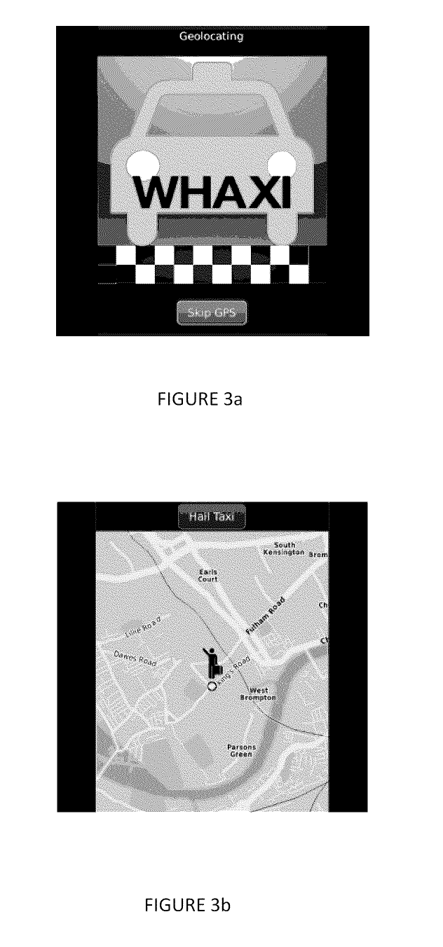

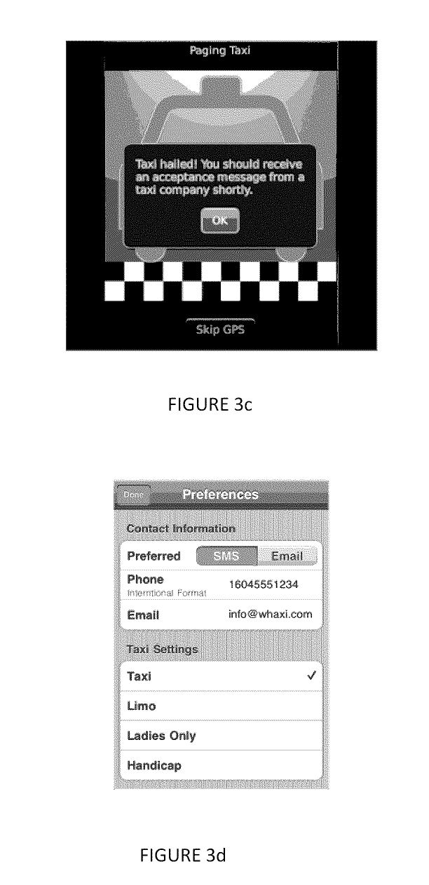

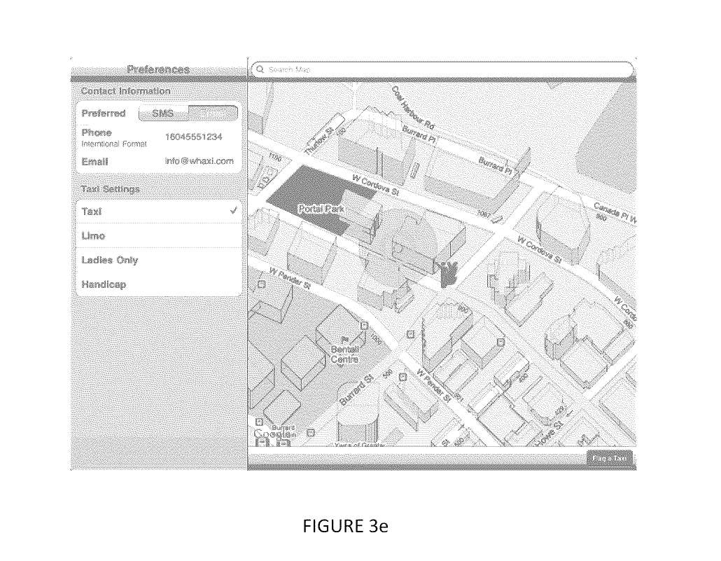

FIGS. 3a to 3e display images that may be shown in mobile device 100. FIG. 3a shows an opening screen or icon on mobile device 100. FIG. 3b shows a screen whereby the user 10 can see their location and initiate the request for a taxi. FIG. 3c shows a screen indicating the request has been sent to the server. FIG. 3d shows a screen whereby a user can input a confirmation address or number to which messages can be sent and indicate preferences. FIG. 3e shows a similar screen, but also takes advantage of a larger screen size available on an iPad or laptop to also show the location of the user.

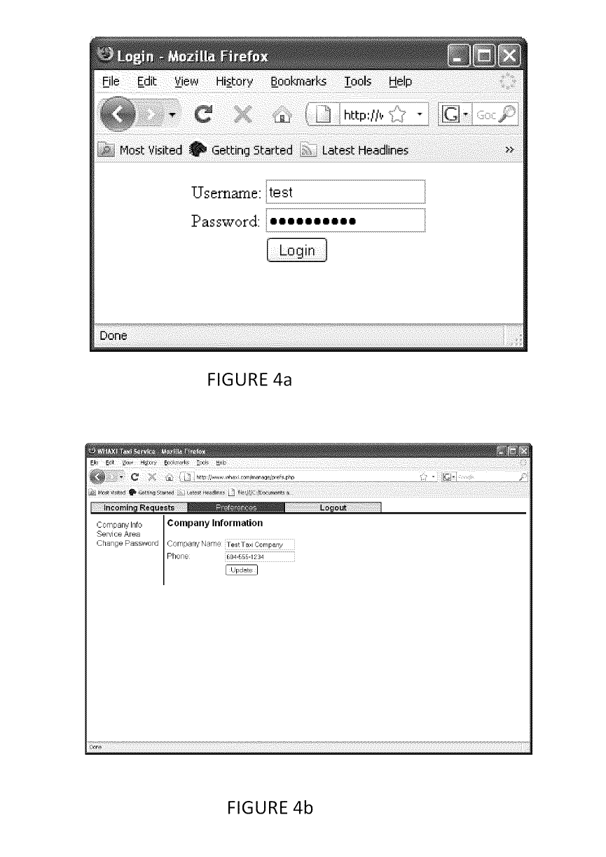

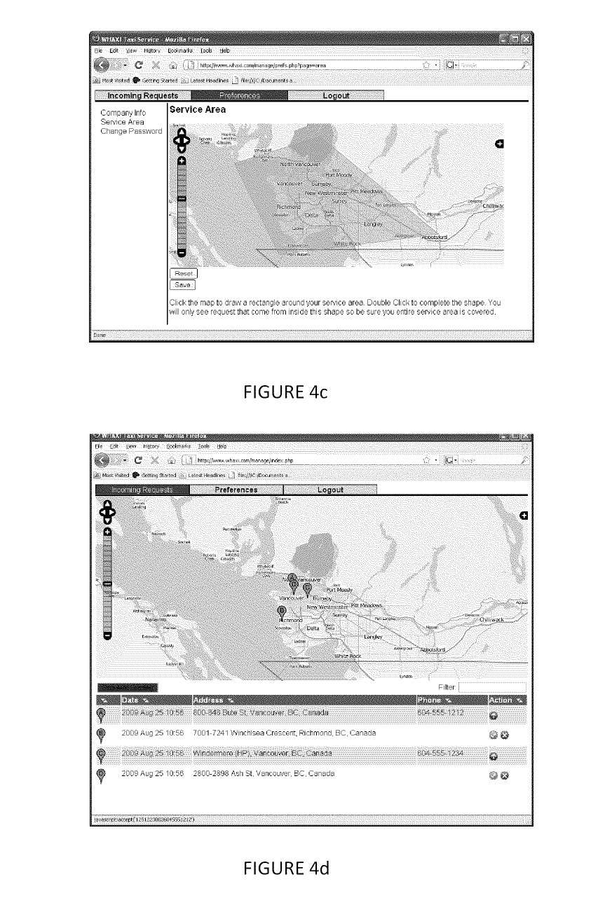

FIGS. 4a to 4d show screen interfaces that may appear on displays 500 used by a service provider. FIG. 4a shows a login screen whereby a service provider can access service provider interface 450. FIG. 4b shows a screen which allows service provider 400 to change login data. FIG. 4c shows a map of the indicated service boundary of a service provider which may be changed by the service provider. FIG. 4d shows a screen which displays requests received from mobile devices 100. Note in the embodiment shown in FIG. 4d, confirmation address (i.e. phone numbers) are displayed with some of the requests.

In an alternative embodiment of the invention, the selection of requests could be automated. For example, software could be used to analyze the location of available taxis relative to received requests, and automatically accept a request should an available taxi be within a predetermined distance of the request (and the distance could vary depending on factors such as the number of available taxis).

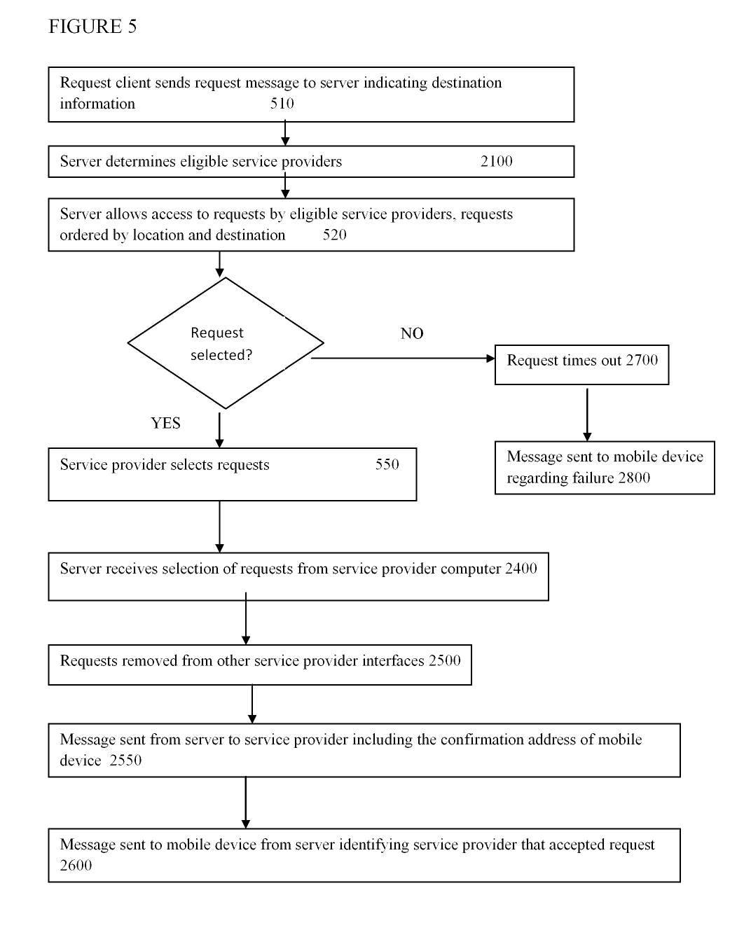

Alternatively, the system according to the invention can be used to facilitate ride sharing. The method showing the process is shown in FIG. 5. In such an embodiment, user 10 indicates a desire or willingness to share a service, such as a taxi with another user 10, when making their request (step 510). When requesting the service, user 10 also provides a destination (and may also provide an indication of the number of passengers). The destination allows the service provider to determine if other requests to that same, or a nearby, destination are available.

Server 300 may display share options in a group on display 500 (step 520), so that requests having similar locations and directions to their destinations are listed near each other. This allows service providers to quickly assess where such requests are being made from, and the spatial coordinates and vectors allow the service providers to quickly assess when such requests have destinations in the same direction. The requests are provided with an indication that they are available for sharing and will have a checkbox or other indicia, so that multiple requests may be selected before the acceptance is provided to server 300 (step 550). The rest of the method proceeds as described above with respect to a single request being accepted.

This allows service providers to overcome certain inefficiencies. For example, it is not unusual for a taxi to travel from a downtown to a suburban location, and then need to return to the downtown empty. This wastes time and resources. With sharing, at least the taxi can be full when it travels to the suburbs, rather than several taxis making the same trip back and forth. Users 10 obviously save on fares, as they will pay a portion of the fare, and the taxi will be able to charge cumulatively more for several sharing passengers.

While the above embodiment has generally been described wherein the service provider is an entity such as a taxi dispatcher, the system and method according to the invention can be applied to individual taxis or courier services. In such an embodiment, service provider computer 400 is likely a mobile device or GPS system on which the spatial coordinates can be overlaid.

Another feature that may be incorporated into the system and method according to the invention, is to allow the user to indicate where they would like to be picked up, and perhaps, their destination, using a map displayed on mobile device 100. Such information becomes part of the request for transmission to sever 300. The destination may be a general area or district, or a more precise address, or spatial coordinates.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via ASICs. However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

I claim:

1. A method of providing an on-demand service to a requester selectable from a plurality of requesters, each of said requesters at an associated location, each of said requesters having an associated mobile device, comprising:
a) said mobile devices communicating said requests for said service to a server, said request including said location associated with said mobile device;
b) said server displaying at least some of said requests to each of said plurality of providers through an interface to said server, each of said requests including the location of said associated mobile device;
wherein on selection of a request by a provider, said server removes said selected request from display to said plurality of providers thereby preventing a second provider from selecting said request.

2. The method of claim 1 wherein when said provider selects said request, said server sends a confirmation to said mobile device.

3. The method of claim 2 wherein said provider that selected said request provides said service.

4. The method of claim 3 wherein said server sends a second confirmation, said second confirmation sent to said provider selecting said request.

5. The method of claim 4 wherein said request includes an address for use in contacting said mobile device.

6. The method of claim 5 wherein said server sends said confirmation using said address.

7. The method of claim 6 wherein, if no service provider selects said request within a predetermined time period, said request is removed from display to said plurality of providers and a failure message is sent to said mobile device from said server.

8. The method of claim 7 wherein said second confirmation includes an address to contact said mobile device.

9. The method of claim 1 wherein said request is removed from said displays immediately following selection of said request.

10. The method of claim 1 wherein said mobile device communicates said request, including said location, and information for use in contacting said mobile device, by actuation of a single button on said mobile device.

11. The method of claim 10 wherein said services are taxi services.

12. The method of claim 11 wherein at least one of said plurality of service providers is a taxi dispatcher.

13. The method of claim 12 wherein at least one of said plurality of service providers is a taxi cab.

14. The method of claim 13 wherein a destination is provided in said request.

15. The method of claim 14 wherein said server displays said request only to eligible service providers of said plurality of service providers.

16. The method of claim 1 wherein said eligibility of said plurality of service providers is based on said location associated with said request.

17. The method of claim 16 wherein at least one of said service providers indicates on said display the geographical boundaries to which said service provider is eligible to provide service.

18. The method of claim 17 wherein said service provider may change said boundary by indicating a second boundary on said display.

19. The method of claim 1 wherein said location is represented in spatial coordinates.

20. The method of claim 19 wherein said spatial coordinates are displayed on a digital map.

21. A system for providing an on-demand service to a requester selectable from a plurality of requesters, each of said requesters at a location, said requesters each having an associated mobile device, comprising:
a) a server, said server configured to receive requests for said service from said mobile devices, said requests including said location associated with said mobile devices and a confirmation address for use in contacting said mobile device;
b) said server accessible by said plurality of providers, each of said providers enable to view requests for which said service provider is eligible, including the location of said associated mobile device;
wherein on selection of a request by a provider, said server removes said selected request from display to said plurality of providers thereby preventing a second provider from selecting said request.

22. A method of providing a service to a plurality of requesters, each of said requesters at a location, said requesters each having a mobile device, comprising:
a) said mobile device communicating said requests for said service to a server, said request including said location associated with said mobile device and a destination associated with said requester;
b) said server displaying said requests, said locations and said destinations to each of said plurality of providers, said requests displayed in an order associated with proximity of said locations and direction of said destinations, each of said requests associated with a selection indicator
c) one of said service providers selects two or more of said requests by selection of said selection indicator; wherein on selection of a request by a provider, said server removes said selected requests from display to said plurality of providers; and
d) said server sending confirmation to said selected requesters including an identity of said selecting service provider.
